(19) United States
(12) Patent Application Publication
(10) Pub. No.: US 2021/0404557 A1
(43) Pub. Date: Dec. 30, 2021

(54) VALVE ASSEMBLY

(71) Applicant: Transportation IP Holdings, LLC, Norwalk, CT (US)

(72) Inventor: Balaji Hosadurgam Ravindranath, Bangalore (IN)

(21) Appl. No.: 16/914,717

(22) Filed: Jun. 29, 2020

(51) Int. Cl. F16K 1/20; F16K 21/00

(52) U.S. Cl. CPC F16K 1/20; F16K 24/00; F16K 21/00

(57) ABSTRACT

A valve assembly that may include a stationary device that may be configured to couple to a fluid conduit within the fluid conduit and may include plural opening elements defining a plurality of apertures for passage of a fluid to flow therethrough. The valve assembly may also include a movable device having plural closing elements corresponding to the apertures, and each closing element may be configured to slide into contact with a corresponding aperture to reduce or prevent a flow of the fluid through the corresponding aperture, and the closing element configured to spread a force of the fluid across a face of the closing elements.

### BACKGROUND

### Technical Field

The subject matter described relates to valve assemblies.

### Discussion of Art

Numerous valve assemblies are used for many different applications to control the flow of fluid, including liquids, gases, flowing solids, liquid and gas mixtures, etc. through conduits, or pipes. Such valves may include check valves, butterfly valves, poppet valves, or the like that each functions to allow the passage of the contents flowing through the conduit. For example, a simple check valve may be provided by forming a movable device that may be a disc that is biased by a spring against a flange that encircles the perimeter of the conduit. The size of the disc is less than the inner diameter of the conduit, but greater than the opening formed by the flange such that in a first position the disc blocks 100% of the flow through the conduit. Then when the force of the spring bias is overcome by flowing fluid, the disc moves away from the opening to a second position allowing the flowing contents to move around the perimeter of the disc and through the conduit.

Another type of valve is a butterfly valve. A butterfly valve has a movable device that is the size and shape of the inner diameter of the conduit to 100% block the flow of contents within the conduit in a first position. The moveable device has a pivot axis perpendicular to the flow axis of the conduit and extending through a diameter or length of the moveable device such that the entire device rotates about the pivot axis. The butterfly valve also includes a locking device that holds the butterfly valve in place, preventing rotation about the pivot axis. When flow past the butterfly valve is desired, the moveable device may be manually rotated by an individual about the pivot axis. When rotating 90° to a second position the perimeter of the movable member aligns with the flow axis of the conduit allowing nearly 100% flow through the conduit. Then, when desired, the movable device may be manually rotated back to the first position to again block flow through the conduit.

While butterfly valves are typically effective at blocking fluid flow, they have numerous drawbacks as well. When the flow of the fluid within the conduit are to one side of the pivot axis, a moment force is generated about the pivot access based on the distance between the pivot axis and the force of the fluid. Such moment force causes additional strain on the locking mechanism, and over time can cause locking mechanism failures. To this end, such force can even cause slight movement of the movable device resulting in an opening between the movable device and the inner wall of the conduit. Consequently, leakage can occur as a result of the movement of the movable member.

### BRIEF DESCRIPTION

In one or more embodiments, a valve assembly is provided that may include a stationary device having plural opening elements defining a plurality of apertures disposed about a center axis of the stationary device for passage of a fluid to flow therethrough, and a movable device having plural closing elements corresponding to the apertures, each closing element configured to align with the apertures of the stationary device in a first position, the stationary device having plural closing elements disposed between apertures of the stationary device, the plural closing elements of size and shape to cover the apertures of the stationary device when the movable device is in a second position.

In one or more embodiments, an assembly is provided that may include a stationary device configured to engage a conduit within the conduit and having a pattern of apertures for passage of a fluid to flow therethrough, and a movable device having a pattern of apertures corresponding to the pattern of apertures of the stationary device, the movable device configured to move from a first position wherein the pattern of apertures of the movable device correspond with the pattern of apertures of the stationary device to allow the passage of the fluid through the pattern of apertures of the stationary device, to a second position wherein the pattern of apertures of the movable device correspond with the pattern of apertures of the stationary device to prevent the passage of the fluid through the pattern of apertures of the stationary device.

In one or more embodiments, a valve assembly is provided that may include a stationary device having plural opening elements defining a plurality of apertures disposed about a center axis of the stationary device for passage of a fluid to flow therethrough, and a movable device having plural closing elements corresponding to the apertures, each closing element configured to align with the apertures of the stationary device in a first position, the stationary device having plural closing elements disposed between apertures of the stationary device, the plural closing elements of size and shape to cover the apertures of the stationary device when the movable device is in a second position.

### BRIEF DESCRIPTION OF THE DRAWINGS

The inventive subject matter may be understood from reading the following description of non-limiting embodiments, with reference to the attached drawings, wherein below:

FIG. 1 illustrates a schematic diagram of a valve assembly within a conduit;

FIG. 2 illustrates a front plan view of a stationary device of a valve assembly;

FIG. 3 illustrates a front plan view a movable device of a valve assembly valve assembly;

FIG. 4 illustrates a front plan view of a valve assembly in a first position;

FIG. 5 illustrates a front plan view of a valve assembly in a second position;

FIG. 6 illustrates a front plan view of a stationary device of a valve assembly;

FIG. 7 illustrates a front plan view a movable device of a valve assembly valve assembly;

FIG. 8 illustrates a front plan view of a valve assembly in a first position;

FIG. 9 illustrates a front plan view of a valve assembly in a second position;

FIG. 10 illustrates a front plan view of a stationary device of a valve assembly;

FIG. 11 illustrates a front plan view a movable device of a valve assembly valve assembly;

FIG. 12 illustrates a front plan view of a valve assembly in a first position; and

FIG. 13 illustrates a front plan view of a valve assembly in a second position.

### DETAILED DESCRIPTION

Embodiments of the subject matter described herein relate to a valve assembly. The valve assembly includes both a stationary device and a movable device that rests against the stationary device. The stationary device may include plural opening elements that include a pattern of apertures that allow passage of fluid therethrough. The movable device has closure elements and, similar to the stationary device, includes a pattern of apertures. The movable member additionally rotates about a central axis that is aligned with the fluid axis of the conduit. In a first position, the apertures of the stationary device and the apertures of the movable device align, providing a fluid flow path through the opening elements of the stationary device. When the movable device is rotated to a second position, the closure elements of the movable device align with corresponding opening elements of the stationary device to prevent the flow of fluid through the valve assembly. Because the normal force being applied to both the stationary device and moveable device aligns with the axis of rotation, no rotational force about the axis of rotation occurs, regardless of whether the fluid flows on one side of the conduit or the other. As a result, compared to a butterfly valve, moment forces are eliminated, wear may be reduced, and maintenance, repair and replacement mitigated.

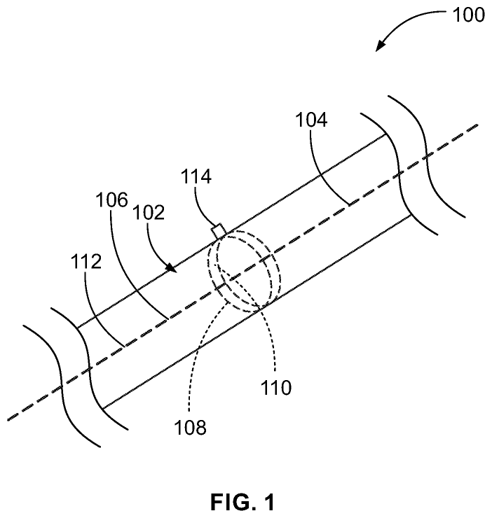

FIG. 1 illustrates a valve assembly 100 disposed within and coupled to a conduit 102. The valve assembly may be coupled to the conduit through welding, fasteners, clips, pressure fit, a combination of the previous methods, or the like. The conduit may be a pipe, tube, channel, duct, etc., and may be of any size, shape or cross-section including circular, square, rectangular, or the like. The conduit conveys fluid 104 that flows along a fluid axis 106. The fluid may be a liquid, gas, solid-liquid combination, liquid-gas combination, water, oil, steam, etc. In one example, the conduit has a circular cross-section with the fluid axis extending along the center of each circle forming the conduit.

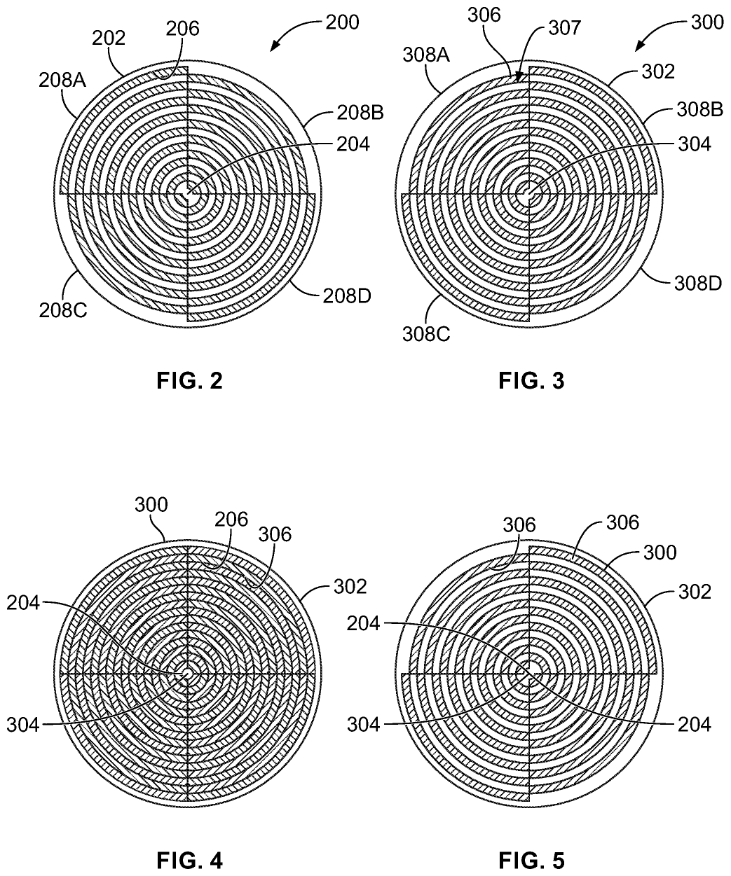

The valve assembly may include a stationary device 108 and a movable device 110. The stationary device may be coupled to the conduit, including being fixed to the conduit through welding, fasteners, clips, pressure fit, or the like. The stationary device may include plural opening elements (FIGS. 2-13) that include plural apertures (FIGS. 2-13) that define each opening element. The plural apertures may be arcuate, straight, polygons, or the like. The plural apertures may also be provided in a pattern. Based on the size, shape, and pattern or patterns of the plural apertures a determined amount of fluid may flow through the stationary device. In one example, between 50%-75% of the potential fluid flowing through the stationary device my flow through the conduit as compared to 100% if the stationary device was not within the conduit. In yet another example more the 75% of the potential fluid flowing through the conduit may pass through the stationary device, but less than 100%.

The movable device includes plural closing elements (FIGS. 2-13) with plural apertures (FIGS. 2-13) between the closing elements. Each closing element is of size and shape to cover, or extend over a corresponding opening element of the stationary device. Similarly, each aperture within the movable device can at least partially aligns with a corresponding aperture of the stationary device. The movable device includes a central axis 112 that aligns with the fluid axis of the conduit. Specifically, the movable device rotates about the central axis. Because the central axis aligns with the fluid axis, no moment force is experienced by the moveable device about the central axis. By eliminating moment forces, only the force of the fluid is transferred to the moveable device and stationary device, reducing wear caused by moment forces, and failures that may be caused by moment forces.

When the movable device is in a first position, the closing elements cover the corresponding opening elements to prevent the flow of fluid through the stationary device. At this time the movable device blocks more than 99%, or approximately 100%, of the fluid from passing through the stationary device. When approximately 100% of the fluid is blocked from flowing through the stationary device, the movable device is considered in a closed position. As the movable device rotates about the central axis, the apertures of the movable device begin aligning with the apertures of the stationary device allowing the fluid to begin to pass through the stationary device. When the movable device reaches a second position, the maximum amount of fluid passes through the stationary device, and the movable device is considered to be in an open position.

In one example, the second position may be a 90° rotation of the movable device, and the apertures of the movable device may all align with corresponding apertures of the stationary device. In one example, the alignment of the apertures causes the blocking of less than 50% of the fluid from flowing through the stationary device. When the movable device moves from the first position to the second position, the amount of fluid blocked from flowing through the stationary device may vary between less than 50% to 99%. Specifically, only the material that forms the plural apertures blocks the flow of the fluid through the stationary device. Thus, the size, shape, and pattern of the apertures determines the amount of fluid blocked within the conduit. In one example, only 10% of fluid flowing through the stationary device is blocked. Additionally, in one example, a stop element may be provided so that the movable device only moves between the first and second position, and thus only rotates 90°. Alternatively, the movable device may rotate 360°. In some embodiments when the movable device may rotate 360° there may be plural positions of rotation when the movable device blocks approximately 100% of the flow of fluid through the stationary device. Similarly, there may be plural positions of rotation when the movable device may allow the maximum amount of flow through the stationary device.

The movable device may also include a slider mechanism 114 that extends from the movable device to the exterior of the conduit. The slider mechanism allows an individual to manually rotate the movable device about the central axis exterior to the fluid conduit. In this manner, an individual, or exterior mechanical device may rotate the valve assembly from the first position to the second position. Alternatively, a communication device may be incorporated into the movable device such that a remote control may cause movement of the movable valve inside the fluid conduit through use of a magnetic field, or otherwise. The slider mechanism may include stop elements to prevent rotation of the movable device past of the first position or second position. Alternatively, a marking, or simple circuit with an indication light may be used to indicate when approximately 100% of the fluid is blocked from flowing through the stationary device, and when the maximum amount of fluid flows through the stationary device. In each instance, the operator of the valve has an indication of the rotational location of the movable device compared to the stationary device.

FIGS. 2-5 illustrate an example valve assembly with a stationary device (FIG. 2), movable device (FIG. 3), and how the stationary device and movable device correspond to one another by rotating the movable device about a central axis from a first position (FIG. 4) to a second position (FIG. 5). While the movable device is illustrated as rotating about the central axis, in other examples, the movable device may slide laterally from the first position to the second position.

FIG. 2 illustrates an example stationary device 200. In one embodiment the stationary device is the stationary device of FIG. 1. The stationary device may be of size and shape to couple within a conduit. In one embodiment, the stationary device may be circular having a periphery 202 extending about a central axis 204. Disposed about the central axis are plural opening elements 206 that define a plurality of arcuate apertures. The stationary device may include four quadrants 208A-D, with an arcuate aperture in the first quadrant offset from a corresponding arcuate aperture in a second quadrant. There may be plural arcuate apertures in each quadrant, with arcuate apertures radially spaced from one another away from the central axis. In one embodiment, the radial distance between each arcuate aperture may be equal, while alternatively, in another embodiment the radial distance between each arcuate aperture may vary. In this manner, the plural arcuate aperture may form a pattern about the central axis.

FIG. 3 illustrates an example movable device 300. In one embodiment, the movable device is the movable device of FIG. 1. The movable device may be of size and shape to couple within a conduit and corresponds to the size and shape of a complimentary stationary device. Specifically, the movable device of FIG. 3 may be complimentary to the stationary device of FIG. 2. Similar to the stationary device of FIG. 2, the movable device may be circular having a periphery 302 extending about a central axis 304. Disposed about the central axis are plural closing elements 306 that space between a plurality of arcuate apertures 307. The stationary device may include four quadrants 308A-D, with a closing element in the first quadrant offset from a corresponding closing element in a second quadrant. There may be plural closing elements in each quadrant, with closing elements radially spaced from one another away from the central axis.

In one embodiment, the radial distance between each closing element may be equal, while alternatively, in another embodiment the radial distance between each closing element may vary. In this manner, the plural closing elements may form a pattern about the central axis. Specifically, the pattern may match the pattern of the stationary device such that the plural arcuate apertures of the movable device may align with the plural arcuate apertures of the stationary device in a first position (FIG. 4), and the plural closing elements of the movable device may align with the plural arcuate apertures of the stationary device in a second position (FIG. 5). While the Figures show the first and second positions, third, fourth, etc. positions are provided between the first position and second position. These additional positions provide partial opening of the opening elements and may be used to vary the flow through the valve assembly.

In the embodiment of FIGS. 2-5, the stationary device and movable device present two discs with the phase shift of 180° that may be slid over each other to block approximately 100% of flow through the stationary device. Specifically, rotating either of the discs by 90° will close or open the valve assembly accordingly. As a result, the valve assembly operation may be provided by a slider mechanism and would need very low actuation force. Additionally, moment forces, or aero torque forces are eliminated because loads are balanced across valve assembly face. Instead, a normal force of the fluid is transferred orthogonal to the stationary device. Additionally, flow uniformity at the outlet may also be enhanced, reducing high velocity fluid flow, and the formation of temperature pockets within the fluid.

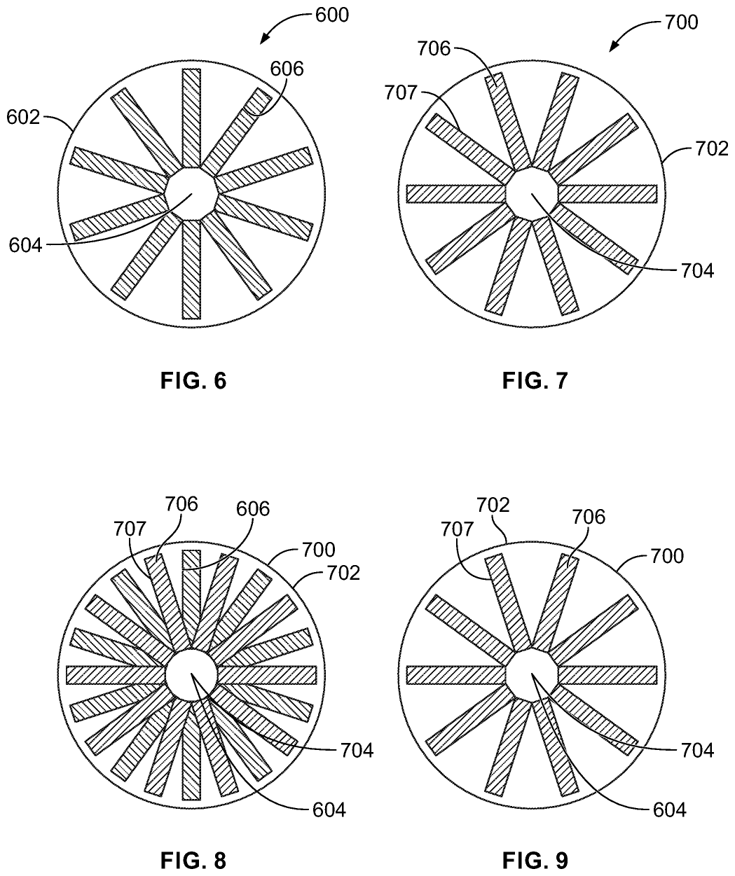

FIGS. 6-9 illustrate an example valve assembly with a stationary device (FIG. 6), movable device (FIG. 7), and how the stationary device and movable device correspond to one another by rotating the movable device about a central axis from a first position (FIG. 8) to a second position (FIG. 9). While the movable device is illustrated as rotating about the central axis, in other examples, the movable device may slide laterally from the first position to the second position.

FIG. 6 illustrates an example stationary device 600. In one embodiment, the stationary device may be the stationary device of FIG. 1. The stationary device may be of size and shape to couple within a conduit. In one embodiment, the stationary device may be circular having a periphery 602 extending about a central axis 604. Disposed about the central axis are plural opening elements 606 that define a plurality of polygon apertures that radially extend from the central axis. Specifically, the polygon apertures may be slots that are generally rectangular in shape and equally spaced about the central axis. While in FIG. 6 ten (10) apertures are illustrated, in other examples twenty or more apertures may be provided, or five or less apertures may be provided. Similarly, while a generally rectangular aperture may be provided, in other examples the aperture may curve, be triangular, etc.

FIG. 7 illustrates an example movable device 700. In one embodiment, the movable device may be the movable device of FIG. 1. The movable device may be of size and shape to couple within a conduit and corresponds to the size and shape of a complimentary stationary device. Specifically, the movable device of FIG. 7 may be complimentary to the stationary device of FIG. 6. Similar to the stationary device of FIG. 6, the movable device may be circular having a periphery 702 extending about a central axis 704. Disposed about the central axis may be plural closing elements 706 that may be spaced between a plurality of polygon apertures 707.

In one example, the closing elements are generally rectangular in shape. Specifically, the closing elements may be of size and shape to cover the opening elements of the corresponding stationary device. In one embodiment, the distance between each closing element may be equal, while alternatively, in another embodiment the distance between each closing element may vary. In this manner, the plural closing elements may form a pattern about the central axis. Specifically, the pattern may match the pattern of the stationary device such that plural polygon apertures of the movable device may align with the plural polygon apertures of the stationary device in a first position (FIG. 8), and the plural closing elements of the movable device may align with the plural polygon apertures of the stationary device in a second position (FIG. 9). While the Figures show the first and second positions, third, fourth, etc. positions may be provided between the first position and second position. These additional positions may provide partial opening of the opening elements, and may be used to vary the flow through the valve assembly.

In the embodiment of FIGS. 6-9, the stationary device and movable device present two discs with the phase shift of 360° divided by the number of polygon apertures that may be slid over each other to block approximately 100% of flow through the stationary device. Specifically, rotating either of the discs by 360° divided by the number of polygon apertures will close or open the valve assembly accordingly. As a result, the valve assembly operation may be provided by a slider mechanism and would need very low actuation force. Additionally, moment forces, or aero torque forces may be eliminated because loads are balanced across valve assembly face. Instead, a normal force of the fluid may be transferred orthogonal to the stationary device. Additionally, flow uniformity at the outlet may also be enhanced, reducing high velocity fluid flow and the formation of temperature pockets within the fluid.

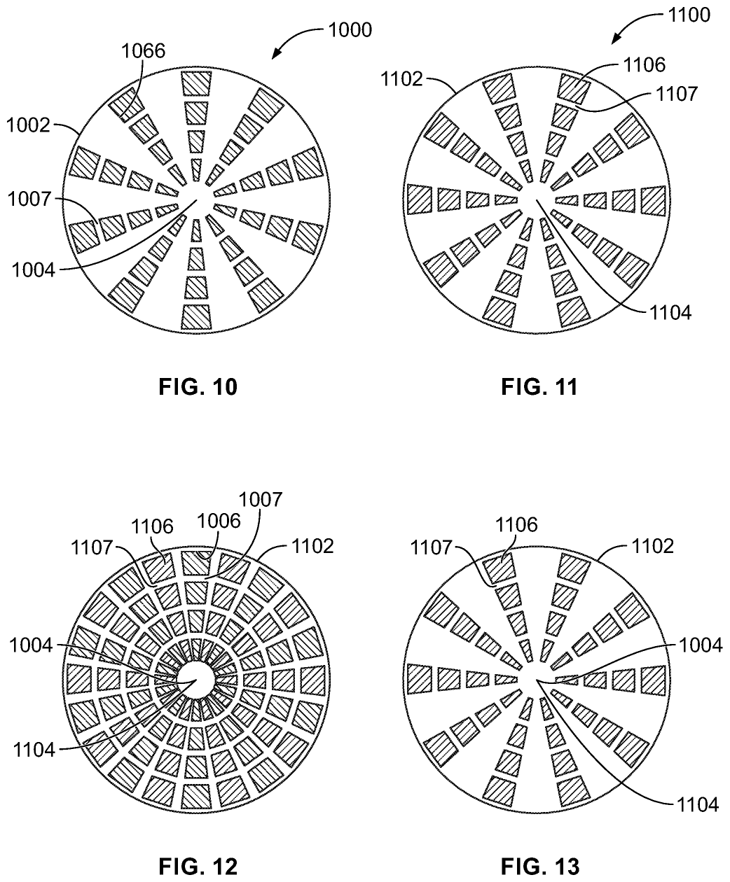

FIGS. 10-13 illustrate an example valve assembly with a stationary device (FIG. 10), movable device (FIG. 11), and how the stationary device and movable device correspond to one another by rotating the movable device about a central axis from a first position (FIG. 12) to a second position (FIG. 13). While the movable device is illustrated as rotating about the central axis, in other examples, the movable device may slide laterally from the first position to the second position.

FIG. 10 illustrates an example stationary device 1000. In one embodiment, the stationary device may be the stationary device of FIG. 1. The stationary device may be of size and shape to couple within a conduit. In one embodiment, the stationary device may be circular having a periphery 1002 extending about a central axis 1004. Disposed about the central axis may be plural opening elements 1006 that define a plurality of polygon apertures that include spacers 1007 within the apertures that radially extend from the central axis. Specifically, the polygon apertures with the spacers may be slots that are generally rectangular in shape and equally spaced about the central axis. While in FIG. 10 ten (10) apertures with spacers are illustrated, in other examples twenty or more apertures with spacers may be provided, or five or less apertures with spacers may be provided. Similarly, while a generally rectangular aperture with spacers may be provided, in other examples the aperture may curve, be triangular, etc. while still including spacers.

FIG. 11 illustrates an example movable device 1100. In one embodiment, the movable device may be the movable device of FIG. 1. The movable device may be of size and shape to couple within a conduit and corresponds to the size and shape of a complimentary stationary device. Specifically, the movable device of FIG. 11 may be complimentary to the stationary device of FIG. 10. Similar to the stationary device of FIG. 10, the movable device may be circular having a periphery 1102 extending about a central axis 1104. Disposed about the central axis are plural closing elements 1106 that space between a plurality of polygon apertures 1107. The closing elements also include openings 1108 that correspond to the spacers of the stationary device.

In one example the closing elements are generally rectangular in shape with the opening corresponding to the spacers of the stationary device provided. Specifically, the closing elements are of size and shape to cover the opening elements of the corresponding stationary device. In one embodiment, the distance between each closing element may be equal, while alternatively, in another embodiment the distance between each closing element may vary. In this manner, the plural closing elements may form a pattern about the central axis. Specifically, the pattern may match the pattern of the stationary device such that plural polygon apertures of the movable device may align with the plural polygon apertures with spacers of the stationary device in a first position (FIG. 12), and the plural closing elements with openings of the movable device may align with the plural polygon apertures with spacers of the stationary device in a second position (FIG. 13). While the Figures show the first and second positions, third, fourth, etc. positions may be provided between the first position and second position. These additional positions may provide partial opening of the opening elements and may be used to vary the flow through the valve assembly.

In the embodiment of FIGS. 10-13, the stationary device and movable device may present two discs with the phase shift of 360° divided by the number of polygon apertures with spacers that may be slid over each other to block approximately 100% of flow through the stationary device. Specifically, rotating either of the discs by 360° divided by the number of polygon apertures with spacers will close or open the valve assembly accordingly. As a result, the valve assembly operation may be provided by a slider mechanism and would need very low actuation force. Additionally, moment forces, or aero torque forces are eliminated because loads are balanced across valve assembly face. Specifically, a normal force of the fluid may be transferred orthogonal to the stationary device. Additionally, flow uniformity at the outlet may also be enhanced, reducing high velocity fluid flow and the formation of temperature pockets within the fluid.

In one or more embodiments, a valve assembly is provided that may include a stationary device that may be configured to couple to a fluid conduit within the fluid conduit and may include plural opening elements defining a plurality of apertures for passage of a fluid to flow therethrough. The valve assembly may also include a movable device having plural closing elements corresponding to the apertures, and each closing element may be configured to slide into contact with a corresponding aperture to reduce or prevent a flow of the fluid through the corresponding aperture, and the closing element configured to spread a force of the fluid across a face of the closing elements.

Optionally, the movable device may be configured to rotate from an opened position to a closed position in a single plane. In another embodiment, the movable device may be configured to move laterally from an opened position to a closed position. In yet another embodiment, the movable device may be configured to transfer a normal force of the fluid orthogonal to the stationary device. In another aspect, each of the apertures may have an arcuate shape partially extending around a central axis of the stationary device. Alternatively, each of the apertures may radially extend from a central axis of the stationary device. In another embodiment, the valve assembly may also include a slider mechanism coupled to the movable device that may be configured to move the movable device from a first position to a second position when manually actuated.

In one or more embodiments, an assembly is provided that may include a stationary device configured to engage a conduit within the conduit and having a pattern of apertures for passage of a fluid to flow therethrough, and a movable device having a pattern of apertures corresponding to the pattern of apertures of the stationary device, the movable device configured to move from a first position wherein the pattern of apertures of the movable device correspond with the pattern of apertures of the stationary device to allow the passage of the fluid through the pattern of apertures of the stationary device, to a second position wherein the pattern of apertures of the movable device correspond with the pattern of apertures of the stationary device to prevent the passage of the fluid through the pattern of apertures of the stationary device.

Optionally, in the first position, the pattern of apertures of the stationary device may align with the pattern of apertures of the moving device. In one embodiment, the pattern of apertures of the stationary device is identical to the pattern of apertures of the movable device. In yet another embodiment, the fluid is at least one of water, steam, or an exhaust gas. In one aspect, the pattern of apertures of the movable device may include apertures that extend radially from a central axis of the movable device. In one embodiment, the assembly may also include a slider mechanism that may be coupled to the movable device that may be configured to move the movable device from the first position to the second position when manually actuated. In one example, the assembly may be an exhaust gas recirculation valve.

In one embodiment, the stationary device and movable device may block less than 50% of the fluid flowing through the conduit in the first position, and the stationary device and moveable device may block at least 99% of the fluid flowing through the conduit in the second position. Optionally, when the movable device moves to a third position between the first position and second position, more than 50% of the fluid flowing through the conduit is blocked while less than 99% of the fluid flowing through the conduit is blocked.

In one or more embodiments a valve assembly is provided that may include a stationary device having plural opening elements defining a plurality of apertures disposed about a center axis of the stationary device for passage of a fluid to flow therethrough, and a movable device having plural closing elements corresponding to the apertures, each closing element configured to align with the apertures of the stationary device in a first position, the stationary device having plural closing elements disposed between apertures of the stationary device, the plural closing elements of size and shape to cover the apertures of the stationary device when the movable device is in a second position.

Optionally, the plural closing elements may be configured to rotate from the first position to the second position laterally in a single plane. In one embodiment, the apertures of the stationary device may each include an arcuate shape extending around the center axis of the stationary device. In another embodiment, the valve assembly may include a slider mechanism coupled to the movable device that is configured to move the movable device from the first position to the second position when manually actuated.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A valve assembly comprising:
a stationary device configured to couple to a fluid conduit within the fluid conduit and having plural opening elements defining a plurality of apertures for passage of a fluid to flow therethrough; and
a movable device having plural closing elements corresponding to the apertures, each closing element configured to slide into contact with a corresponding aperture to reduce or prevent a flow of the fluid through the corresponding aperture, and the closing element configured to spread a force of the fluid across a face of the closing elements.

2. The valve assembly of claim 1, wherein the movable device is configured to rotate from an opened position to a closed position in a single plane.

3. The valve assembly of claim 1, wherein the movable device is configured to move laterally from an opened position to a closed position.

4. The valve assembly of claim 1, wherein the movable device is configured to transfer a normal force of the fluid orthogonal to the stationary device.

5. The valve assembly of claim 1, wherein each of the apertures has an arcuate shape partially extending around a central axis of the stationary device.

6. The valve assembly of claim 1, wherein each of the apertures radially extends from a central axis of the stationary device.

7. The valve assembly of claim 1, further comprising a slider mechanism coupled to the movable device that is configured to move the movable device from a first position to a second position when manually actuated.

8. An assembly comprising:
a stationary device configured to engage a conduit within the conduit and having a pattern of apertures for passage of a fluid to flow therethrough; and
a movable device having a pattern of apertures corresponding to the pattern of apertures of the stationary device, the movable device configured to move from a first position wherein the pattern of apertures of the movable device correspond with the pattern of apertures of the stationary device to allow the passage of the fluid through the pattern of apertures of the stationary device, to a second position wherein the pattern of apertures of the movable device correspond with the pattern of apertures of the stationary device to prevent the passage of the fluid through the pattern of apertures of the stationary device.

9. The assembly of claim 8, wherein in the first position, the pattern of apertures of the stationary device aligns with the pattern of apertures of the moving device.

10. The assembly of claim 8, wherein the pattern of apertures of the stationary device is identical to the pattern of apertures of the movable device.

11. The assembly of claim 8, wherein the fluid is at least one of water, steam, or gas.

12. The assembly of claim 8, wherein the pattern of apertures of the movable device includes apertures that extend radially from a central axis of the movable device.

13. The assembly of claim 8, further comprising a slider mechanism coupled to the movable device that is configured to move the movable device from the first position to the second position when manually actuated.

14. The assembly of claim 8, wherein the assembly is an exhaust gas recirculation valve.

15. The assembly of claim 8, wherein the stationary device and movable device block less than 50% of the fluid flowing through the conduit in the first position, and the stationary device and moveable device block at least 99% of the fluid flowing through the conduit in the second position.

16. The assembly of claim 15, wherein when the movable device moves to a third position between the first position and second position, more than 50% of the fluid flowing through the conduit is blocked while less than 99% of the fluid flowing through the conduit is blocked.

17. A valve assembly comprising:
a stationary device having plural opening elements defining a plurality of apertures disposed about a center axis of the stationary device for passage of a fluid to flow therethrough; and
a movable device having plural closing elements corresponding to the apertures, each closing element configured to align with the apertures of the stationary device in a first position, the stationary device having plural closing elements disposed between apertures of the stationary device, the plural closing elements of size and shape to cover the apertures of the stationary device when the movable device is in a second position.

18. The valve assembly of claim 17, wherein the plural closing elements are configured to rotate from the first position to the second position laterally in a single plane.

19. The valve assembly of claim 17, wherein the apertures of the stationary device each include an arcuate shape extending around the center axis of the stationary device.

20. The valve assembly of claim 17, further comprising a slider mechanism coupled to the movable device that is configured to move the movable device from the first position to the second position when manually actuated.
